(19) United States
(12) Patent Application Publication
(10) Pub. No.: US 2011/0254684 A1
(43) Pub. Date: Oct. 20, 2011

(54) Bag Attachment for Alert Notification and Device Retrieval

(76) Inventor: Vito Antoci, Newport Beach, CA (US)

(21) Appl. No.: 12/769,565

(22) Filed: Apr. 28, 2010

Related U.S. Application Data
(60) Provisional application No. 61/326,181, filed on Apr. 20, 2010.

(51) Int. Cl. G08B 1/08

(52) U.S. Cl. 340/539.13

(57) ABSTRACT

Some embodiments provide a bag attachment that provides wireless alert notifications for messages received on a portable communication device. The bag attachment includes a clasp, a short range radio, a speaker, and a tether. The clasp attaches the attachment to a bag or other personal item carrying article. The short range radio establishes a link and wirelessly exchanges messages with the portable communication device. The speaker produces audible alerts that notify a user of an incoming message. The tether is used to quickly locate and retrieve the portable communication device upon receiving a message. The bag attachment further includes removable faceplates that provide different ornamentation to the bag attachment. The bag attachment may be used as a decorative accessory for the bag while still alerting the user of incoming message. In this manner, the user may stow away the portable communication device without fear of missing an alert.

### CLAIM OF BENEFIT TO RELATED APPLICATIONS

This application claims the benefit of U.S. Provisional Application 61/326,181, entitled “Wireless Alert Notification Device”, filed Apr. 20, 2010.

### TECHNICAL FIELD

The present invention relates to a bag attachment that provides alert notifications and facilitates retrieval of a portable communication device.

### BACKGROUND

Portable communication devices have been integrated into many facets of everyday life and are now commonly carried on one's person throughout the day. These devices include cellular telephones, smartphones, portable digital assistants (PDAs), and messaging devices. These devices are connected to a mobile communication network through which the devices receive and send messages. When a message is received, the devices provide audio alerts (e.g., ringtones or chimes) or motion feedback (e.g., vibration) to notify the user. However some messages, including voice calls and push-to-talk communication, are time sensitive communications and require the user to respond to the message in a timely manner.

Users often do not hear the alerts or do not sense the motion feedback because the device is stowed within a purse, bag, briefcase, pocket, or other personal item carrying article. In public places with large amounts of ambient noise, the audio alert of the device may become inaudible even when the device is within the user's range of hearing or sight. In other cases, the user hears the alert or senses the feedback, but is unable to locate the device in time to answer the message.

One solution is to equip the portable communication devices with a short range wireless technology, such as Bluetooth™, that provides a real-time active or passive connection to the portable communication device. Using the short range wireless technology, a secondary device with a smaller interface may be used to wirelessly communicate through the primary device (e.g., cellphone, smartphone, or laptop) while the primary device is left at a distance from the user or is hidden from the user's view. One such secondary device is a Bluetooth equipped headset.

The Bluetooth equipped headset transmits and receives audio signals from the primary device. However in order for the user to be notified of any incoming messages through the headset, the user must retain the headset on the user's body (e.g., attached over the ear) at all times. These devices are often uncomfortable to wear for long periods of time and are unsightly when worn in public places. Furthermore, certain locations may require the user to remove the headset.

Accordingly, there is a need to improve how a user receives alert notifications for incoming messages received on a portable communication device that is away from the user's immediate reach. There is further a need to improve how the user retrieves the portable communication device once the alert is provided.

### SUMMARY OF THE INVENTION

Some embodiments provide an attachment for a bag, purse, briefcase, or other personal item carrying article that (i) alerts users of messages received on a portable communication device and (ii) facilitates the retrieval of the device such that the user can respond to the message in a timely manner. The bag attachment of some embodiments includes a decorative clasp, a decorative wireless alert notification device, and a tether.

The clasp attaches the wireless alert notification device to a feature (e.g., handle, strap, or buckle) of any bag, purse, briefcase, or other personal item carrying article. The wireless alert notification device serves as a decorative adornment for the bag while also alerting the user to any incoming messages. Specifically, the wireless alert notification device notifies a user of messages received on a portable communication device that is wirelessly linked to the wireless alert notification device. The wireless alert notification device uses interchangeable decorative faceplates whereby the user can customize the appearance of the device.

The tether is linked to the clasp at one end and the portable communication device on the other end. By following the tether from the clasp, a user is able to quickly retrieve the portable communication device irrespective of its location within the bag once an alert is provided by the wireless alert notification device. The tether therefore allows the user to stow the portable communication device within the bag without worry of being unable to retrieve the portable communication device in time to respond to an incoming message.

The wireless alert notification device provides real-time alert notifications as the messages are received on the portable communication device. The wireless alert notification device may also provide reminder alert notifications of missed or pending messages. The portable communication device includes cellular telephones, smartphones, portable digital assistants (PDAs), and other wireless equipped portable electronics. The messages include notifications of incoming voice calls, notifications of incoming push-to-talk calls (i.e., walkie-talkie functionality), and notification of other messages such as voicemail notifications, instant messages, text messages, or multimedia messaging service (MMS) messages.

In some embodiments, the wireless alert notification device provides alerts including audible alerts, sensory alerts (e.g., vibration), and visual alerts. In some embodiments, the audible alerts are customizable to provide different ringtones or sounds for different messages. The visual alerts may include flashing lights or may be used to convey information such as caller identification (callerID) information to the user.

The wireless alert notification device wirelessly connects to the portable communication device using a short range wireless communication protocol. In some embodiments, the short range wireless communication protocol is the Bluetooth protocol though it should be apparent that other short range wireless communication protocols (e.g., IrDA, IEEE 802.15, etc.) may also be used. The wireless alert notification device retains the connection to the portable communication device in order to receive incoming messages. When a message is received, the wireless alert notification device processes the message and provides an alert to the user.

### BRIEF DESCRIPTION OF THE DRAWINGS

In order to achieve a better understanding of the nature of the present invention a preferred embodiment of the bag attachment will now be described, by way of example only, with reference to the accompanying drawings in which:

FIG. 1 illustrates a decorative bag attachment that wirelessly notifies users of incoming messages on a portable communication device and provides means to quickly retrieve the portable communication device in accordance with some embodiments.

FIG. 2 illustrates the tether used in combination with the wireless alert notification device in accordance with some embodiments of the bag attachment.

FIG. 3 conceptually illustrates the components of the wireless alert notification device of some embodiments.

FIG. 4 illustrates an exemplary Bluetooth protocol stack implemented by the Bluetooth module of some embodiments.

FIG. 5 illustrates interchangeable decorative faceplates used to change the appearance of the wireless alert notification device in accordance with some embodiments.

FIG. 6 presents a process performed by the wireless alert notification device for alerting a user of incoming messages in accordance with some embodiments.

FIG. 7 presents a message exchange between the wireless alert notification device and the portable communication device when receiving an incoming voice call message in accordance with some embodiments.

### DETAILED DESCRIPTION OF THE INVENTION

In the following detailed description of the invention, numerous details, examples, and embodiments of the bag attachment are set forth and described. However, it will be clear and apparent to one skilled in the art that the bag attachment is not limited to the embodiments set forth and that the bag attachment may be practiced without some of the specific details and examples discussed.

I. Bag Attachment

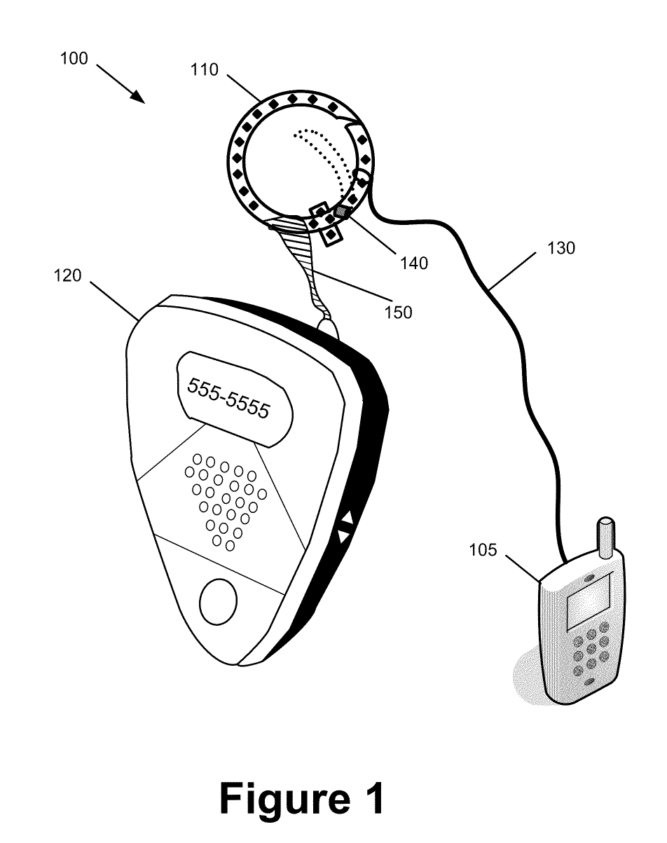

In accordance with some embodiments, FIG. 1 illustrates a decorative bag attachment 100 that (i) wirelessly notifies a user of incoming messages on a portable communication device 105 and (ii) provides means to quickly retrieve the portable communication device 105 such that the user can timely respond to the incoming message. The bag attachment includes clasp 110, wireless alert notification device 120, and tether 130.

The clasp 110 is a circular or “Q” shaped ring that couples the wireless alert notification device 120 and tether 130 to a bag, purse, briefcase, or other personal item carrying article. Specifically, the clasp 110 includes a spring loaded latch 140. When the latch 140 is pressed, the latch 140 opens inward allowing the clasp 110 to be placed around a handle, buckle, strap, or other feature of a bag, purse, briefcase, or other personal item carrying article. When the latch 140 is released, the spring loaded latch 140 closes the clasp 110 thereby coupling the bag attachment 100 to the feature of the bag. It should be apparent to one of ordinary skill that the clasp 110 may be used to couple the bag attachment 100 to other personal items or articles of clothing such as a pant belt strap. In this manner, the user does not attach the wireless alert notification device 120 directly on his/her person. This is in contrast to headsets and earpieces that require the user to place the headset or earpiece onto the ear in order to receive message alerts from the headset or earpiece.

In some embodiments, the clasp 110 is bejeweled or includes other forms of decorative ornamentation. Users can customize the look of the bag attachment 100 by inserting and removing ornaments or charms to and from the clasp 110. Accordingly, the bag attachment 100 is used as a decorative accessory to adorn the bag while also providing alert and device retrieval functionality.

To provide the alert functionality, the bag attachment 100 includes the wireless alert notification device 120. The wireless alert notification device 120 is coupled to the clasp 110 with flexible cording 150. In some embodiments, the cording 150 is a decorative leather braided cord though it should be apparent that the cording 150 may include other forms of cording such as a linked chain.

The wireless alert notification device 120 wirelessly links to many common portable communication devices including cellular telephones, smartphones, portable digital assistants (PDAs), and other wireless equipped portable electronics. In FIG. 1, the wireless alert notification device 120 wirelessly links to and exchanges messages with the portable communication device 105.

When a message is received on the portable communication device 105, the message is sent via the established wireless link to the wireless alert notification device 120. The wireless alert notification device 120 issues one or more alerts to notify a user of the received message. Since the wireless alert notification device 120 is placed on the outside of a bag, the user is notified of the message even when the alert of the portable communication device 105 is inaudible. For example, the alert of the portable communication device 105 will be inaudible when it is stowed within a purse or is carried around a public place with loud ambient noise.

The wireless alert notification device 120 provides real-time alert notifications as the messages are received on the portable communication device 105. The device 120 may also provide reminder alert notifications of missed or pending messages. The alerts notify users of incoming messages that include voice calls, push-to-talk calls, voicemail notifications, instant messages, text messages, or multimedia messaging service (MMS) messages.

In some embodiments, the wireless alert notification device 120 issues alerts that include audible alerts, motion alerts (e.g., vibration), and visual alerts. In some embodiments, the audible alerts are customizable to provide different ringtones or sounds for different messages. The visual alerts may include flashing lights or may be used to convey information such as caller identification (callerID) information to the user.

Accordingly, the clasp 110 and wireless alert notification device 120 allow a user to stow away the portable communication device 105 without worry of missing an incoming message and without the discomfort of attaching a device to the person of the user (e.g., headset or earpiece). However, a shortcoming of some devices that merely provide alerts is their inability to assist the user in locating the portable communication device. In many instances, the user must not only be notified of the alert but also be able to respond to the alert in a timely manner. For example, if the user does not pick up an incoming voice call in time, the call is missed and the caller is redirected to voicemail. Therefore, some embodiments of the bag attachment 100 include the tether 130.

The tether 130 attaches to the clasp 110 and the portable communication device 105 and is used to locate the portable communication device 105 irrespective of where the device 105 is located. Using the tether 130, users can stow the portable communication device 105 anywhere within a bag, purse, briefcase or other personal item carrying article without worrying about being able to retrieve the device 105 in time to respond to a time sensitive message.

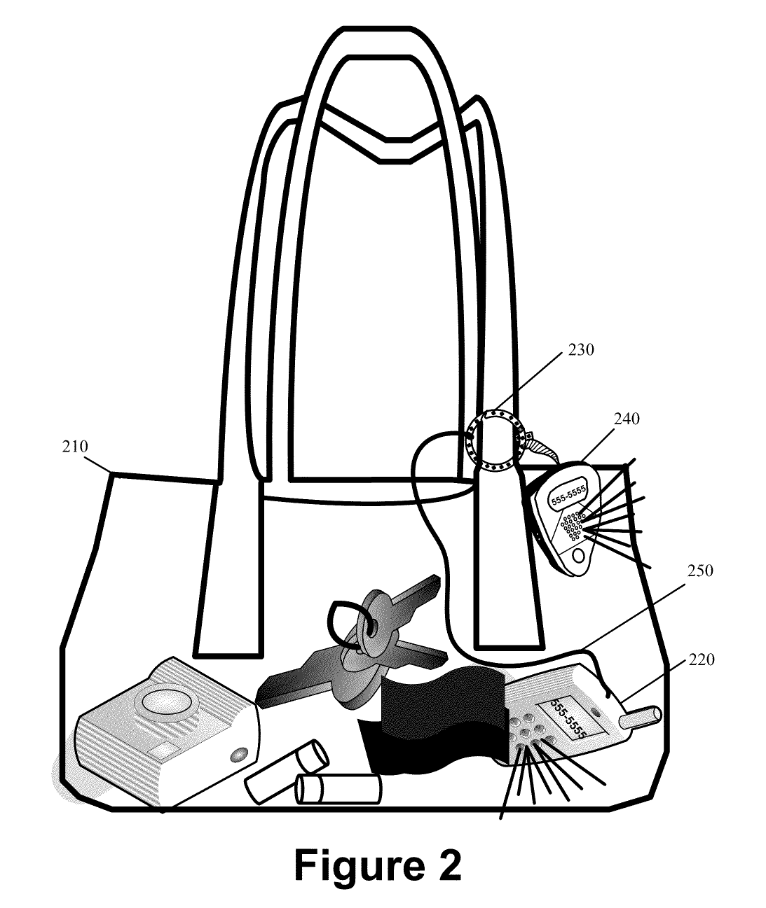

FIG. 2 illustrates the tether used in combination with the wireless alert notification device in accordance with some embodiments of the bag attachment. The figure includes bag 210, mobile phone 220, and the bag attachment of FIG. 1 with clasp 230, wireless alert notification device 240, and tether 250.

The mobile phone 220 is located inside of the bag 210 along with several other items. The items in the bag 210 clutter the bag and make it difficult for a user to identify and retrieve the mobile phone 220 from the bag 210 when it is ringing or vibrating. Additionally, the mobile phone 220 alerts may become muffled and inaudible when located inside the bag 210.

The combination of the wireless alert notification device 240 with the tether 250 alerts the user to incoming messages on the mobile phone 220 and facilitates the retrieval of the mobile phone 220 so that the user may respond to a time sensitive message in time. Specifically, when the wireless notification device 240 alerts the user to an incoming message, the user follows the tether 250 from the bag attachment to locate the mobile phone 220 in the bag 210. The user may pull on the tether 250 to retrieve the mobile phone 220 from inside the bag 210. In this manner, the user does not waste time sifting through the bag to identify the phone 220. By following or pulling the tether 250, the phone 220 is retrieved with sufficient time to allow the user to respond to any time sensitive incoming message.

The tether 250 is a length of flexible cording that couples at one end to the clasp 230 and to the mobile phone 220 at the other end. In some embodiments, the tether 250 couples at one end to the mobile phone 220 with the other end coupling to an easily accessible feature of the bag 210 (e.g., handle, strap or buckle) or to the wireless alert notification device 240. In some embodiments, the user attaches and detaches the tether 250 from the mobile phone 220 or clasp 230 using a spring loaded latching mechanism located on each end of the tether 250.

In some embodiments, the tether 250 serves as a decorative charm accessory for the bag attachment. The tether 250 may be composed of a stylized (e.g., braided, colored, or otherwise designed) length of leather, flexible metal, chain, or plastic. The length of tether 250 varies upon its application. Different bags may require longer lengths of tether 250 and smaller purses may require shorter lengths of tether 250.

II. Wireless Alert Notification Device

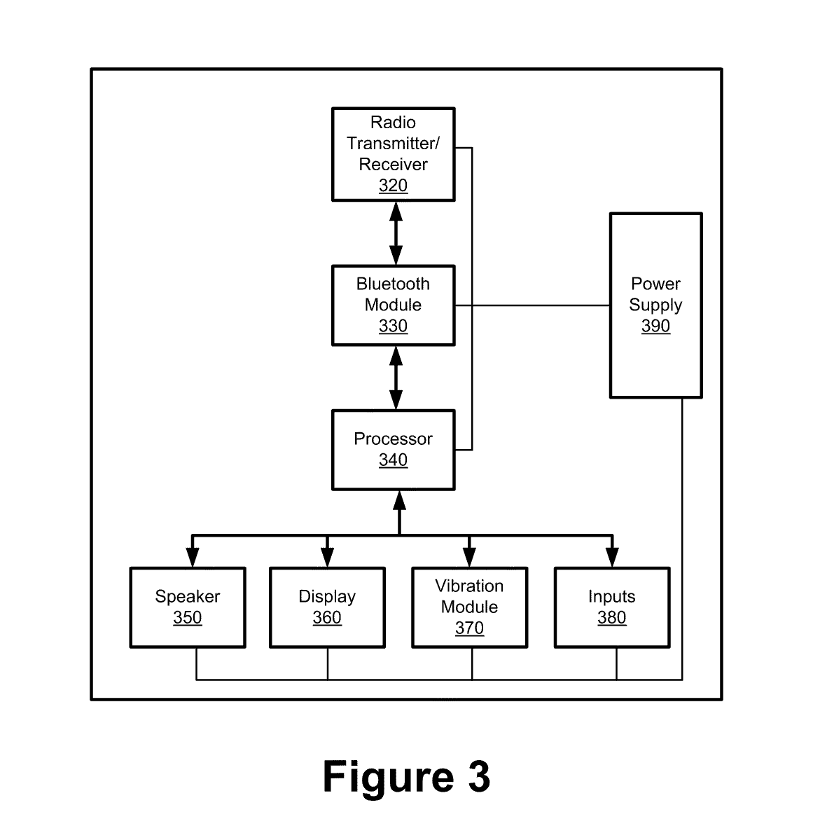

FIG. 3 conceptually illustrates the components of the wireless alert notification device 310 of some embodiments. The device 310 includes: radio transmitter/receiver 320, Bluetooth module 330, processor 340, speaker 350, display 360, vibration module 370, inputs 380, and power supply 390.

The radio transmitter/receiver 320 modulates signals traveling to and from the device 310. In some embodiments, the radio transmitter/receiver 320 operates over the Bluetooth spectrum (i.e., 2.4 GHz). The radio transmitter/receiver 320 may include an antenna to amplify the signals.

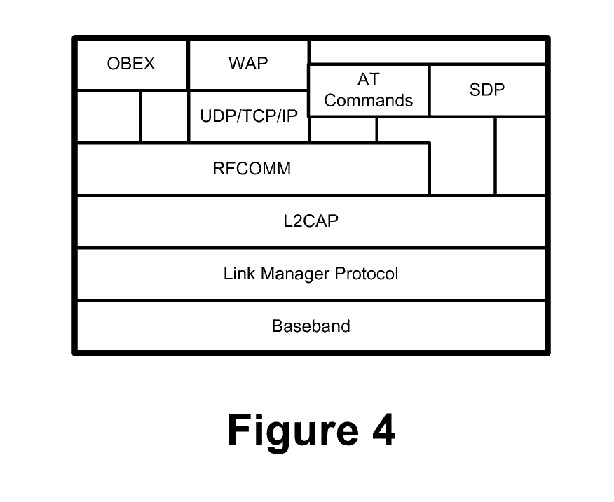

The Bluetooth module 330 implements the Bluetooth protocol stack that is used to decipher the wireless messages received at the radio 320 and to encode messages that are sent wirelessly to another device through the radio 320. FIG. 4 illustrates an exemplary Bluetooth protocol stack 440 implemented by the Bluetooth module 330 of some embodiments. The layers and protocols within the Bluetooth protocol stack 440 are not described in detail below as they are well known in the art and are implemented according to industry specifications. It should be apparent that the Bluetooth module 330 may be implemented with some or all of the layers and protocols depicted in FIG. 4.

With reference back to FIG. 3, the wireless alert notification device 310 includes processor 340 to execute various functionality (e.g., issuing various alerts) based on any received messages or user interaction with the device 310 (e.g., button press). The processor 340 interprets the incoming messages and determines the appropriate function to execute based on the incoming message. For example, when receiving an incoming call message, the processor 340 determines whether to issue an audible alert by generating sound from the speaker 350, a visual alert by presenting callerID information on the display 360, or to produce a sensory alert by causing the vibration module 370 to vibrate for a specified period of time.

In some embodiments, the processor 340 generates messages that are sent to the portable communication device. For instance, when a user silences an alert on the wireless alert notification device 310, the processor 340 generates a message to also silence the alert issued on the portable communication device. The processor 340 generated message is sent through the radio transmitter/receiver 320 to the portable communication device. The processor 340 may perform device management functions such as providing an alert when the device 310 is about to go out of range and lose link with the portable communication device.

The display 340 provides visual alerts to the user. The visual alerts include providing callerID information, scrolling a text message, or flashing lights to silently but visually notify the user of an incoming message. The display 340 may include a light emitting diode (LED) screen, liquid crystal display (LCD), or other display technology screen.

In some embodiments, the speaker 350 produces different auditory alerts. For instance, different ringtones may be used to identify different messages or different callers. Similarly, the vibration module 370 may produce different lengths or patterns of vibration to identify different messages or different callers.

Inputs 380 are different buttons with which the user interacts with the device 310. Inputs 380 include a volume rocker that controls the volume level or that can be used to place the device 310 into a silent mode whereby only sensory or visual alerts are presented to the user. Inputs 380 include an on/off button that is used to power on and power off the device. Other inputs 380 are used to discontinue an alert (i.e., mute), establish link with the portable communication device, change the display 360 brightness, and change the type of alert (visual only, sensory only, audible only, or some combination). It should be apparent to one of ordinary skill in the art that the device 380 may include some or all of the described inputs 380 and that two or more functions may be controlled via a single input. For example, the on/off button may be used to power on and off the device using long button presses (e.g., 5 seconds) and to establish the short range wireless link using short button presses (e.g., single click).

The power supply 390 provides power to the various components 320-380. The power supply 390 may include a permanent rechargeable battery, a removable rechargeable battery, or a replaceable battery.

It should be apparent to one of ordinary skill in the art that the wireless alert notification device 310 depicted in FIG. 3 illustrates components for some embodiments of the device 310. Some other embodiments of the device 310 may include additional or fewer components than those depicted in the figure. For example, the wireless alert notification device 310 may include a light and an input button to utilize the light as a flashlight. The light may also be used to convey device status to the user (e.g., link established or low battery). The device 310 may include a microphone that provides speakerphone functionality to the device 310 so that the user may be alerted of a phone call and may participate in the phone call without retrieving the portable communication device.

In some embodiments, the wireless alert notification device 240 includes interchangeable decorative faceplates to customize the look of the device 240 according to user preferences. In this manner, the device 240 may be used as a visual accessory that adorns the bag 210 while providing alert notification functionality.

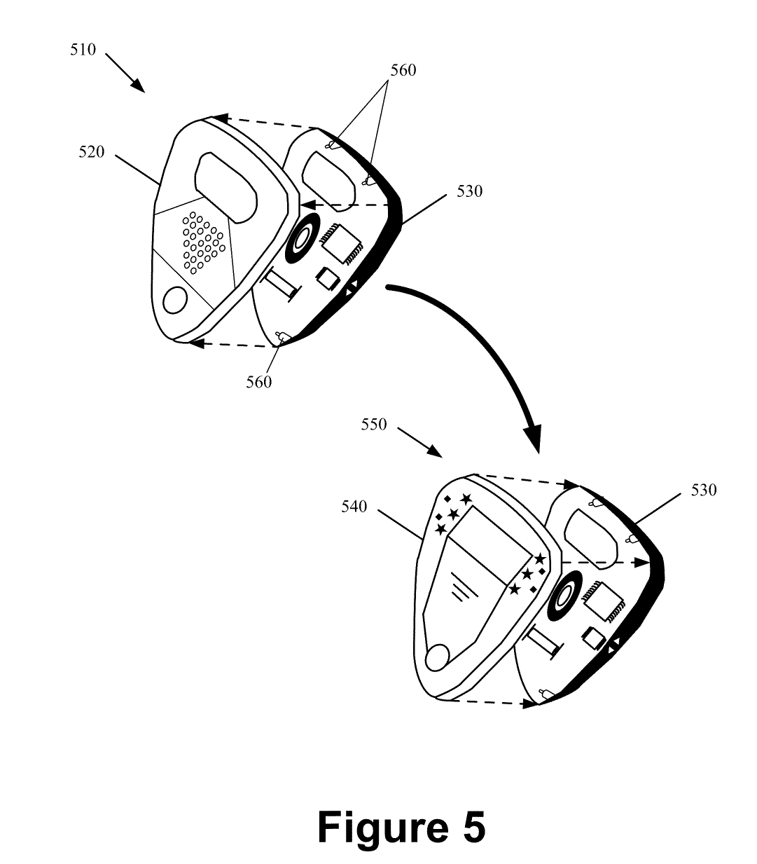

FIG. 5 illustrates interchangeable decorative faceplates that alter the appearance of the wireless alert notification device in accordance with some embodiments. As shown at 510, a first faceplate 520 is removed from the base 530 of the wireless alert notification device and a second faceplate 540 is placed onto the base 530 at 550.

The faceplates 520 and 540 snap into position on the base 530 using the connection pegs 560 affixed to the base 530. The faceplates 520 and 540 may be composed of plastic or other rigid materials. The base 530 houses the components of the wireless alert notification device as described with reference to FIG. 3.

Each faceplate may include different color schemes, markings, designs, patterns, and decorative ornamentation (e.g., jewels, crystals, etc.). The different faceplates allow a user to customize the look of the wireless alert notification device and thereby use the device as a visual accessory that enhances the aesthetic look of the bag, purse, briefcase, or other personal item carrying article.

In some embodiments, the width of the faceplate and base at the top of the wireless alert notification device measures 2-4 inches, the length of the faceplate and base measures 3-6 inches, the thickness measures 0.4-1.5 inches. The wireless alert notification device has a weight of 2-8 ounces.

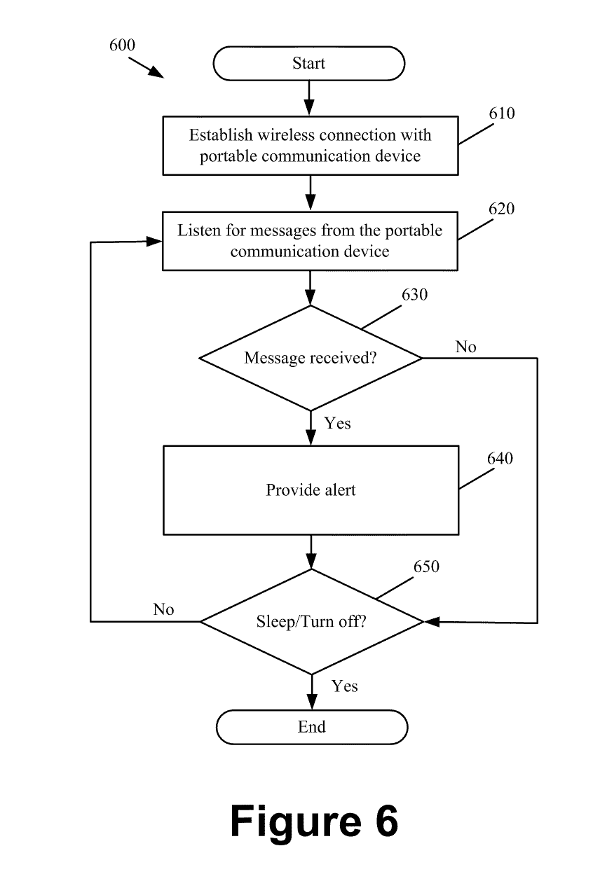

FIG. 6 presents a process 600 performed by the wireless alert notification device for alerting a user of incoming messages in accordance with some embodiments. The process 600 commences by establishing (at 610) a short range wireless link between the wireless alert notification device of some embodiments and a portable communication device. In some embodiments, the wireless alert notification device automatically attempts to establish a link with any nearby device when powered on. Additionally, the user can initiate the linking process (610) through a particular button press sequence (e.g., holding a button designated for establishing link for five seconds).

In some embodiments, the wireless link is a Bluetooth™ connection. Bluetooth allows for a link to remain active for up to 30 feet of distance between two Bluetooth equipped devices. In some embodiments, the wireless alert notification device provides a particular alert when the wireless alert notification device nears losing link with a portable communication device because of the distance between the devices. It should be apparent to one of ordinary skill in the art that the wireless link may be established using one or more different short range wireless protocols. For example, the wireless link between the wireless alert notification device and the portable communication device may be established using the IrDA or IEEE 802.15 protocols.

After establishing the short range wireless link, the wireless alert notification device listens (at 620) for incoming messages from the portable communication device over the established link. When a message is received (at 630), an alert is issued (at 640) to notify the user of the incoming message. The process continues to listen for incoming messages (at 620-630) until the wireless communication device is turned off (at 650) or the link between the devices is lost.

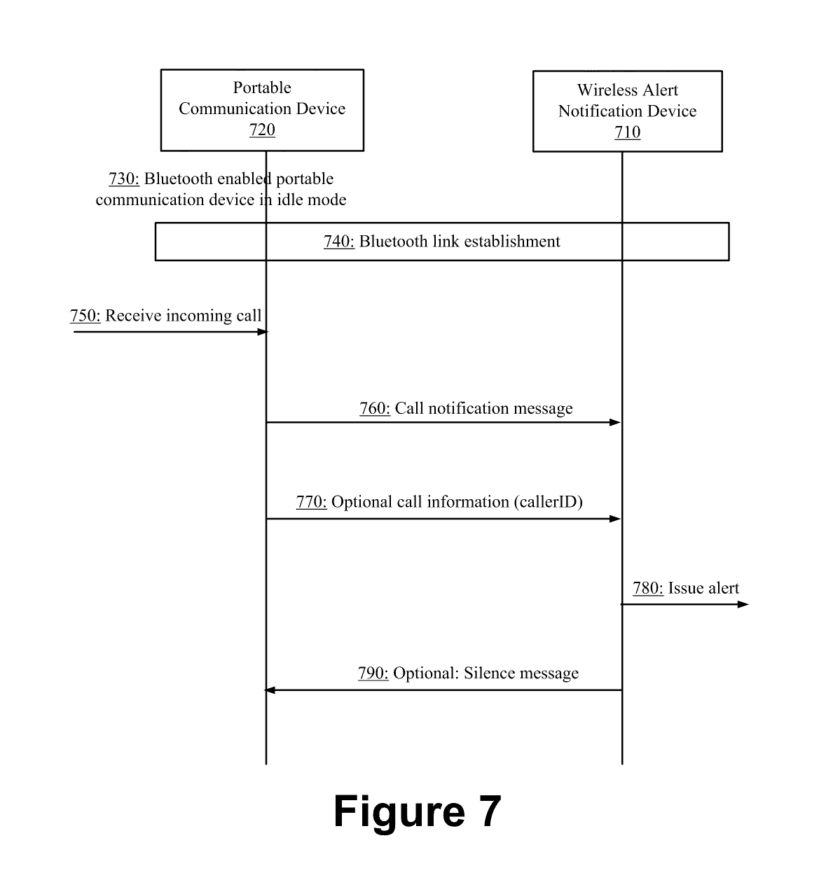

FIG. 7 presents a message exchange between the wireless alert notification device 710 and the portable communication device 720 when receiving an incoming voice call message in accordance with some embodiments. The Bluetooth functionality of the portable communication device 720 is enabled (at 730) such that the Bluetooth link establishment procedure occurs at 740. During the Bluetooth link establishment procedure, the devices 710 and 720 create the necessary physical layers, control layers, and logical layers for intercommunication.

When the portable communication device 720 receives (at 750) an incoming call, the device 720 passes (at 760) a call notification message to the wireless alert notification device 710 over the established Bluetooth link. Optional information may be passed (at 770) in the call notification message or in a separate message. The optional information may specify caller identification information such as the call originator's telephone number or name from a phonebook directory. In some embodiments, the optional information includes text of an incoming text message or instant message.

The wireless alert device 710 processes the incoming message and issues (at 780) a corresponding alert to notify the user of the arrival of the message. As noted above, the alert may include an audible alert, motion alert, visual alert, or some combination thereof. The user can silence the alert on the wireless alert device 710 and silence the alert of the portable communication device 720 by sending (at 790) an optional silence message from the wireless alert notification device 710 to the portable communication device 720 over the Bluetooth link.

While the invention has been described with reference to numerous specific details, one of ordinary skill in the art will recognize that the invention can be embodied in other specific forms without departing from the spirit of the invention. Thus, one of ordinary skill in the art would understand that the invention is not to be limited by the foregoing illustrative details, but rather is to be defined by the appended claims.

I claim:

1. A bag attachment comprising:
a clasp for attaching said attachment to a bag;
a short range radio for wirelessly exchanging messages with a portable communication device;
a speaker for producing an audible alert to notify a user of a message that is received on the portable communication device; and
a tether for connecting to said portable communication device to identify a location of the portable communication device.

2. The bag attachment of claim 1, wherein said tether is attached to said portable communication device and a feature of said bag.

3. The bag attachment of claim 1, wherein said tether is attached to said portable communication device and said clasp.

4. The bag attachment of claim 1 further comprising a removable ornamental faceplate for altering a look of the attachment.

5. The bag attachment of claim 1 further comprising a display for visually displaying information related to the message received on the portable communication device.

6. The bag attachment of claim 1 further comprising at least one input for silencing said audible alert.

7. The bag attachment of claim 1 further comprising a processor for processing messages and for controlling operation of said speaker.

8. The bag attachment of claim 1, wherein said message comprises at least one of an incoming telephone call, incoming text message, and incoming Multimedia Messaging Service (MMS) message.

9. The bag attachment of claim 1, wherein the short range radio uses Bluetooth signaling.

10. The bag attachment of claim 1 further comprising a vibration module for generating vibrations that alert a user of a received message.

11. The bag attachment of claim 1, wherein the portable communication device comprises at least one of a cellular telephone, smartphone, portable digital assistant, and laptop computer.

12. A bag attachment comprising:
a clasp for coupling said bag attachment to a feature of a bag;
a wireless alert notification device coupled to said clasp, said device for generating alerts based on messages received from a portable communication device wirelessly linked with said wireless alert notification device; and
a cord coupled to said clasp at one end and to said portable communication device at an opposite end, said cord for identifying a location of said portable communication device.

13. The bag attachment of claim 12 further comprising a set of decorative charms to accessorize said bag.

14. The bag attachment of claim 12, wherein said clasp comprises a spring loaded latch for coupling said clasp to the feature of the bag.

15. The bag attachment of claim 14, wherein said feature comprises at least one of a handle, buckle, or strap of said bag.

16. A method of alerting a user to messages received on a portable communication device, the method comprising:
providing an alert notification device (i) to wirelessly exchange messages with said portable communication device, and (ii) to issue an alert upon receiving a message from said portable communication device; and
providing a tether to retrieve said portable communication device when said alert notification device issues an alert.

17. The method of claim 16 further comprising providing a clasp to couple said alert notification device and said tether to a personal item carrying article.

18. The method of claim 16, wherein said alert comprises at least one of an audible alert, sensory alert, and visual alert.
